(19) United States
(12) Patent Application Publication
(10) Pub. No.: US 2003/0182209 A1
(43) Pub. Date: Sep. 25, 2003

(54) Electronic restaurant service management system

(76) Inventors: Li Ge, Prospect, KY (US); Chenxi Yang, Prospect, KY (US); Rong Ge, Houghton, MI (US)

Correspondence Address: Li Ge, 10509 Mountain Ash Ln, Prospect, KY, 40059, US

(21) Appl. No.: 10/104,187

(22) Filed: Mar. 25, 2002

(51) Int. Cl. G06F 17/60

(52) U.S. Cl. 705/27

(57) ABSTRACT

An automatic menu display, service request, order entry and management system used in restaurant comprises of a central server, Electronic Assistant Terminals (EAT) and service location terminals. The central server synchronizes the menu display, dispatches service requests and order entries to appropriate service locations, including kitchen, cashier, service desk and bar. All the information related to sales and requests are stored in a database located on the central server. The Electronic Assistant Terminals display image or text menu, transmit service requests and order entries as well as display summarized customers' order statement and bill statements. The EATs are placed on each table adjacent to each seat, talking to the center control server through wireless connection. The service location terminals include service desk terminals, kitchen terminals, cashier terminals and office terminals. Service desk terminals prompt the request contents, such as drinks, foods, special services, and their origins. Service personnel bring the proper items to correct locations. Kitchen terminal shows the request food items. Restaurant managers can access database from office terminals, check current service status, view reports, analyze sales and update menu.

### BACKGROUND

1. Field of Invention

This is an electronic restaurant service and management system, which can simplify the traditional service procedures and improve service efficiency and quality. This invention can also extend restaurant electronic management.

2. Description of Related Art

In traditional restaurant environment, waiters write down customers' orders and manually input them into computer system or handle them directly to kitchen. Customer may experience such problems as, when they need service, e. g. ordering, checking out or adding items, they cannot find waiter. However, when they are studying the menu, enjoying the food or chatting, waiters keep disturbing. Simply asking for a cup of water could take half an hour. Another problem is the order might be delayed if waiter carries it to kitchen, especially when there is a high customer volume. While the customers complain of the long waiting time, the restaurant owners are also headache of the too much time and money spent in training new employee.

Various systems and programs have been created in an attempt to expedite the service and cut the cost. For instance, U.S. Pat. No. 5,845,263 to Camaisa, et al. uses portable computer and video monitor showing photo-realistic image for interactively ordering restaurant menu items. However, this system is not convenient because it needs every customer to input a lot of information, which has no nothing to do with food, just to identify customer. It is not cost efficient either because every customer terminal has its own database and disk. And ordering food is only partial restaurant services. Besides ordering food, customer may have other requirements, for instance, adding beverage, question about food, asking for napkins, etc., where a lot of customer idle time still exists.

U.S. Pat. No. 5,235,509 to Mueller, et al. describes a method and apparatus for facilitating self-ordering of items in a fast food environment. Customers place their own orders by touching a video console to reduce errors and theft by counter employees. This system is targeted to a high-density, short duration fast food operation. However, in a fast food environment, where lines of customers are frequently encountered, some patrons are intimidated or confused and may require human assistance, which slows down the entire system.

U.S. Pat. No. 6,208,976 to Kinebuchi, et al. describes a method of operating order management system, which uses terminal devices connecting to management equipment to take orders. In this system, the terminal devices connect with the management equipment by lines; thus, the terminal devices are not portable. And this system will not be equipped to any existing restaurant easily due to the lined connection.

Besides the shortcomings listed above, all of the previous self-ordering systems don't include a monitor method to guarantee the service quality. That means when a customer enters an order or other service request, there is no way to measure how long it takes to accomplish the service. In order to improve the service quality, a system should monitor and analyze the time delay between request and serving.

It is also desirable that a system can take care of all the customers' requirements simply and inexpensively, making the customers feel comfortable and convenient when they are enjoying food. At the same time, the system can enhance the efficiency and profitability of restaurants. That is what this invention can solve.

### SUMMARY OF THE INVENTION

This invention is a computer system involving both software and hardware. The system is composed of central server computers and service location terminals, including customer's Electronic Assistant Terminals (EATs), kitchen terminal(s), service desk terminal(s), cashier terminal(s) and office terminal(s), which are connected by wireless or wired LAN. Customers, waiters, kitchen staffs and restaurant managers can acquire or transmit commands through their terminals. The central server coordinates the terminals and updates data in database.

Electronic Assistant Terminals (EATs) are small hand-held devices. They are placed on each table adjacent to each seat with their own electronic identification code, connecting to server computer by wireless networks. Service personnel can locate each seat simply by the EATs electronic identification code. The EATs have a graphic display device, showing graphic and text menu items, which are loaded from servers whenever a synchronizing procedure is triggered. Optionally, the EATs can show other information such as the restaurant tradition, nutrition facts, health tips or weather information. The EATs can also send out customer requests, receive responses from other terminals and display service status. Customers can use buttons, touch screen, mouse or possible speech recognition to browse the menu and select their requests. The menu order requests will be routed to the kitchen terminal through the server, and special service requests, e.g. drinks, napkins, forks etc., will be routed to the service desk terminal through the server too. Some optional functions of EATs include merging bill and credit/debt card payment. EATs have minimum software and hardware configurations because their main functions are simply menu display, command transmission and status display. The EATs are low power consuming device, which can be powered by rechargeable battery.

The server computer receives the message/data from all of the terminals and dispatches them to the destinations or save them to database. The minimum hardware requirement for server computer includes wireless and wire network connection, storage device, CPU, memory, output device and display device. The server software package dispatches the terminal requests and responses, renders the dynamic graphic and text EATs menu, and operates database management.

Kitchen Terminal can be a display device, a computer or a printer. It will list orders immediately after a customer requests the order. An optional function of kitchen terminal is sending back order status to EATs and service desk terminals. The order status includes “Food item is being prepared”, “Food item is done” and “Food item is coming” etc.

All waiters or service staffs wait at service desk terminal(s), checking the incoming customers' requests and locating the origins. This routine design saves half of the waiters' trip since they can always bring the right item to the right person once they see the requests from the service desk terminal. And it saves customer's waiting idle time too. A typical service desk terminal can be a display device, a computer or a printer. An optional function of the service desk terminal is sending an acknowledgement back to the original sender. Whenever a customer requests service, the message will be displayed on the service desk terminal. As to the checkout request, the message will be displayed on both the service desk terminal and the cashier terminal, and a bill will be printed out. Customer is able to view his bill on his EAT and chooses his favorite payment method.

Office terminal is usually placed in an office. It is a computer with customized software running on it. The software can pull out the data from database, show current service status, generate the periodical sale reports, analyze good consuming and inventory, etc.

### BRIEF DESCRIPTION OF THE DRAWINGS

FIG. 1 is an exemplary of restaurant layout with the electronic system arrangement.

FIG. 2 is a hardware block diagram of an Electronic Assistant Terminal (EAT) component.

FIG. 3 is an exemplary view of an embodiment of an Electronic Assistant Terminal and its desktop recharger/base.

FIG. 4 is a hardware and functional block diagram of a Server computer.

FIG. 5A is a diagram of the EAT request message sending procedure.

FIG. 5B is a diagram of the kitchen terminal's message responding procedure.

FIG. 5C is a diagram of the service desk terminal's message responding procedure.

FIG. 6A is a Unified Modeling Language (UML) illustration of customer's food ordering procedure.

FIG. 6B is a UML illustration of customer service request/response procedure.

FIG. 6C is a UML illustration of customer checking out procedure.

FIG. 7 is a data flow diagram of an EAT user interface and operating procedure.

FIG. 8 is an exemplary menu display of an embodiment of Electronic Assistant Terminal.

FIG. 9 is an exemplary order display of an embodiment of Electronic Assistant Terminal.

FIG. 10 is an exemplary software display of an embodiment of service desk terminal.

FIG. 11 is an exemplary user interface of service analysis report application.

FIG. 12 is an exemplary user interface of Menu Administration application.

FIG. 13 is an exemplary user interface of Sale Report application.

### DETAILED DESCRIPTION

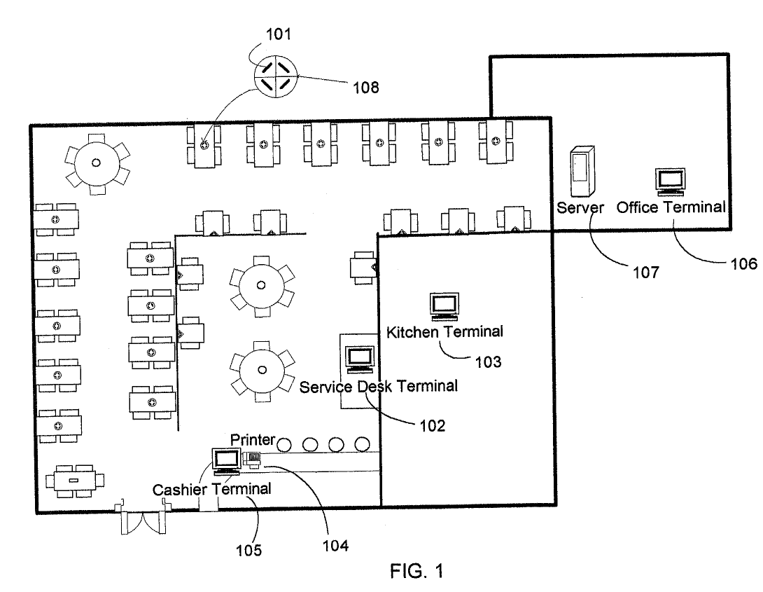

Referring to FIG. 1, a typical restaurant layout with Electronic Restaurant Service Management System in the present invention can be seen. Plurality of Electronic Assistant Terminals 101, which are grouped in EAT desk top rechargers/bases 108, are placed on each table adjacent to each seat for convenient access of individual customer. Service desk terminal 102 is placed on the service desk where all the waiters or service staffs obtain service requests. In kitchen area, at lease one Kitchen Terminal 103 exists. A bill printer 104 and Cashier Terminal 105 are placed on reception desk. Server 107 and office Terminals 106 are placed in office. The EATs 101 communicate with Server 107 by the wireless connection. All the other terminals can be connected by wired or wireless networks.

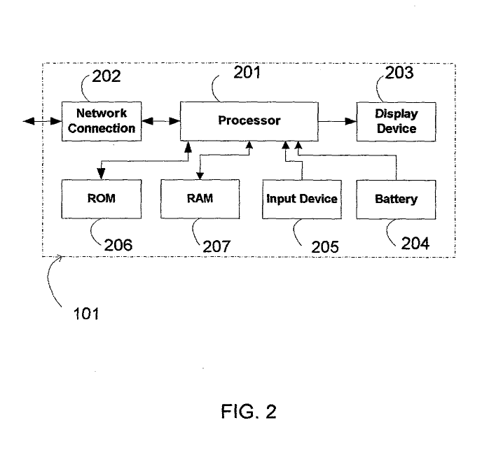

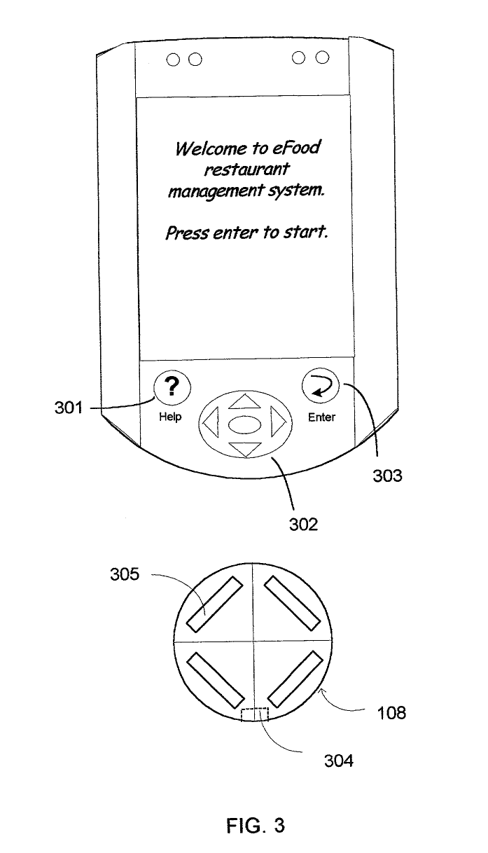

FIG. 2 is a hardware functional block of EAT and FIG. 3 is the physical view of EAT and EAT desktop recharger/base. In order to fit the existing restaurant settings, EATs should be small devices with as few cords as possible. The EAT hardware components are all low-power devices, operated by rechargeable battery. The processor 201 can be a microprocessor, an Application Specific Integrated Circuit (ASIC), a programmable device or a hard-wired processor. Since the power consumption is critical for EAT, properly choosing and using device must be considered. The three main power consumption devices of EAT are processor 201, display device 203 and network connection 202. The presently preferred processor is Intel designed StrongARM processor. The network connection 202 is idled most of the time. The EAT network connection can use existing elaborated protocol e. g. 802.11b, bluetooth etc., however, it is preferable to use simple low cost, low power Instrumentation, Scientific and Medical (ISM) band device, such as using TRF6900A, Single-Chip RF Transceiver. Every network packet is self-contained. The broadcast messages and the acknowledging signals from receivers are required to guarantee a transmission. This kind of network connection only exists between EATs and the server. EAT device is a customer's agent sending out requests to proper terminal destinations via the server. There is no communication between any two EATs. Since the packet sent out from EAT is small and self-contained, it is not necessary to maintain a dedicate connection between EAT and server.

The rest terminals and the server use elaborated IP based protocol to communicate. The display device 203 can be a color or black and white LCD. Both ROM 206 and RAM 207 are required in EAT. ROM records the selection logic and the terminal identification code while RAM stores the dynamic menu and the customer information. The input device 205 is an abstract device, which can be software input or a hardware device. Among the hardware devices, the navigation button(s) or touch screen is preferred than the mouse. An exemplary of the embodiment of the present invention uses the navigation buttons as the input method. Software input refers to Automatic Speech Recognition (ASR) technique. The EAT device is powered by rechargeable battery 204, which is designed at least continually sustaining 20 hours without recharging.

FIG. 3 shows the physical view of an EAT device and its desktop recharger/base. On the front panel, small number of buttons make the EAT device easy to operate. Service button 301 directly sends a message to the service desk terminal for all the uncategorized service requests. Navigation buttons 302 browse all the menu items and service items. Enter button 303 sends out the selected request. The EAT desktop recharger/base 108 is a 2-in-1 device of recharger and base. Each desktop recharger/base has one power plug 304 and multiple EAT bases 305. The embodiment of the invention can be easily mounted on any existing restaurant and EAT can be conveniently operated by any customer with basic reading skills.

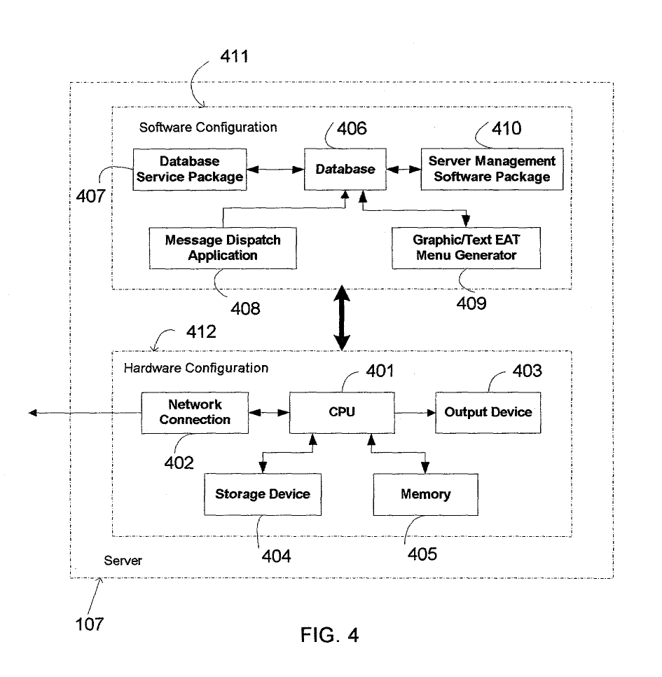

FIG. 4 describes the hardware and software configuration existing on the server computer. The minimum hardware configuration 412 requires CPU 401, network connection 402, output device 403, storage device 404, and memory 405. Network connection 402 can be homogeneous wireless network or mixture wireless/wired network. The wireless protocol can be 802.11b or Bluetooth protocol. In an embodiment of this invention, the wireless connection between EATs and the server computer is ISM band Radio Frequency (RF) network, while all the other wireless connections are 2.4 GHZ by using 802.11b protocol. This consideration is trying to reduce the cost of EAT. Because database management system runs on the server computer, a large storage device 404 is required on the server machine. The memory size 405 depends on the customer software requirements and the scale of the restaurant. A typical software package 411 running on server comprises of database 406, database service package 407, message dispatch application 408, and text/graphic menu service application 409. Whenever the server receives the EAT's synchronization signal, text/graphic menu service application 409 will render the menu information to EAT. The server computer identifies messages from the terminals and dispatches them through message dispatch application 408. The main purpose of Server Management Software package 410 is to do restaurant menu management and reports generation on the server machine.

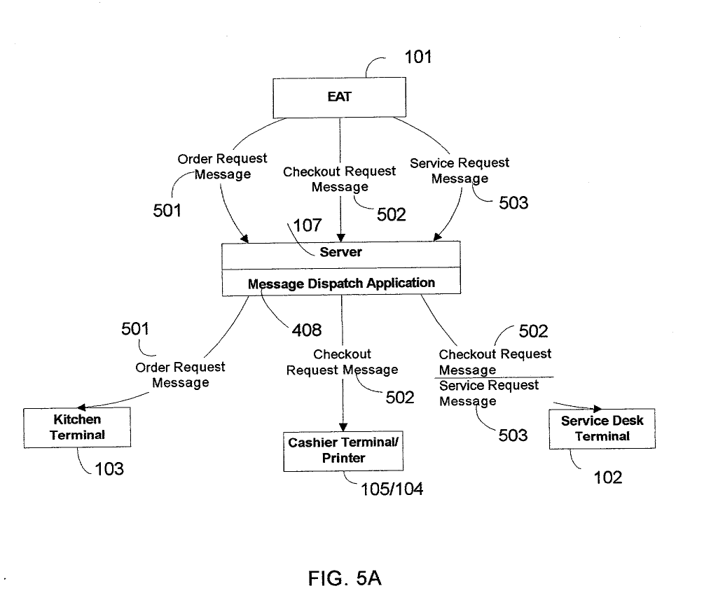

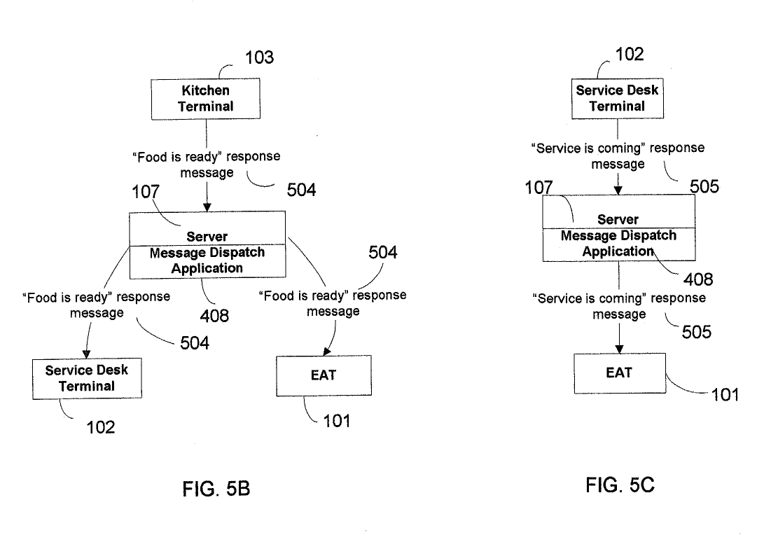

In FIG. 5A, three kinds of messages can be sent out from EATs, that is, order message 501, checkout message 502 and general service message 503. Message dispatch application 408 forwards order message 501 to kitchen terminal 103; checkout message 502 to cashier terminal 105, service desk terminal 102 and bill printer 104; general service message 503 to service desk terminal 102. In FIG. 5B, the “Food is ready” feedback message 504 is forwarded to service desk terminal 102 and the EAT 101 who made the request. Service desk terminal 102 also send a “Service is coming” message 505 back to the EAT 101 who made the service request. This procedure is shown on FIG. 5C.

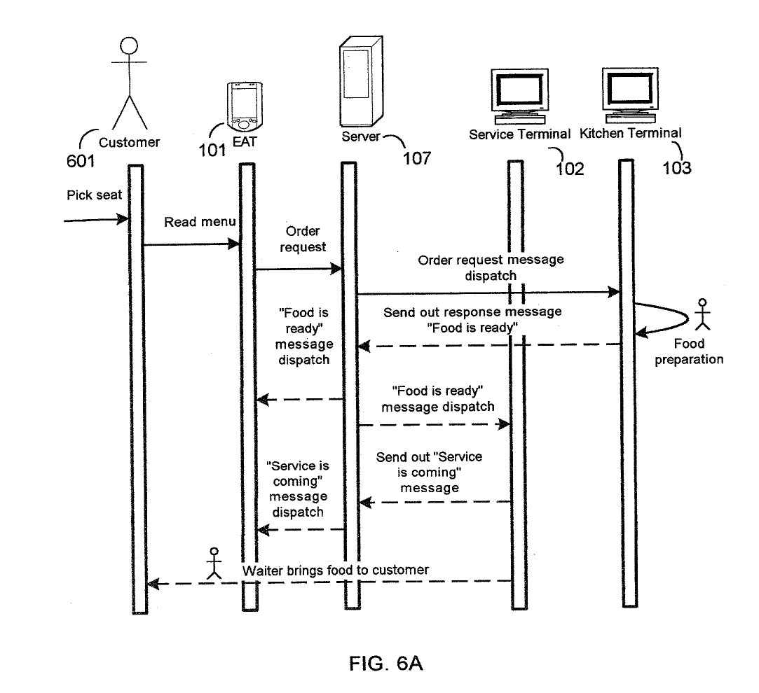

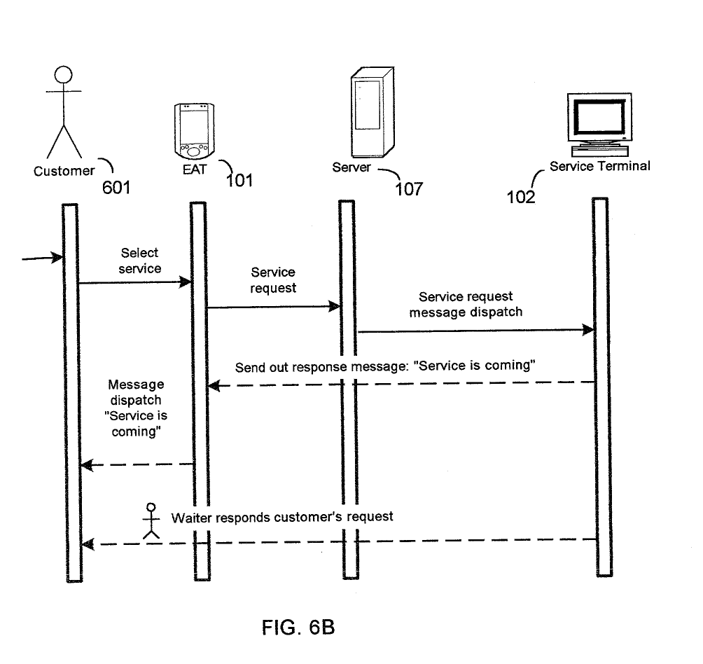

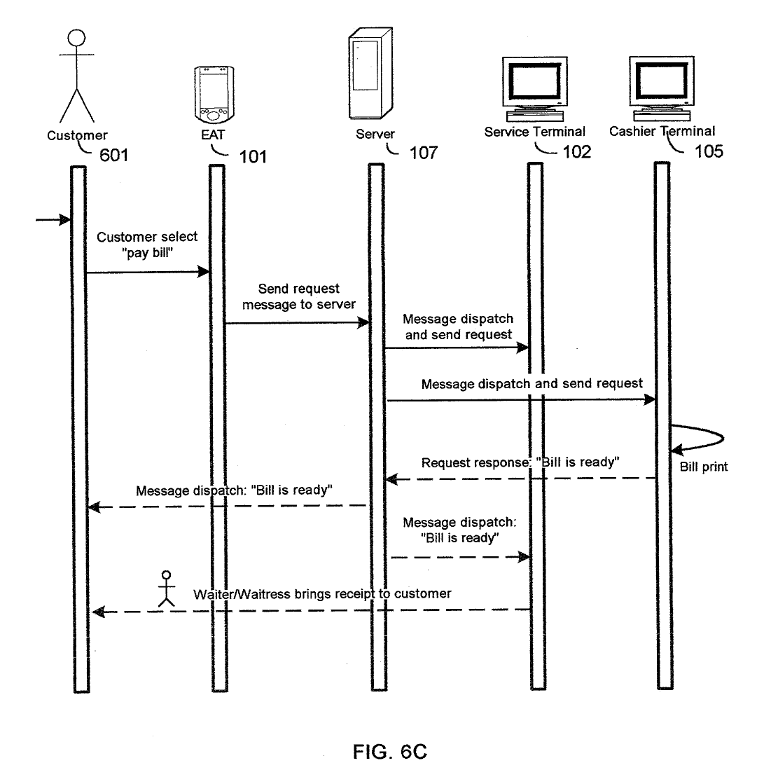

The message forwarding systems mentioned above corresponds to three service procedures illustrated in FIGS. 6A, 6B and 6C. FIG. 6A is a food ordering procedure. After a customer 601 picks a seat, he browses the electronic menu through EAT 101 and enters the food item. The server 107 dispatches the food order to kitchen terminal 103. When the food is done by chef, a “Food is ready” message is sent to the server 107 and the server 107 forwards the message to service desk terminal 102 and the EAT 101 who made the request. At the same time, a “Service is coming” message is sent back to the EAT 101 before the waiter brings the food back to customer 601. The only difference between the general service request procedure and the food ordering procedure is whether the kitchen terminal is involved in the procedure or not. In the general service request procedure FIG. 6B, the service request message is forwarded to the service desk terminal 102 and, mimic to the food ordering procedure, a “Service is coming” message is sent back to the EAT 101 before the waiter brings requested items back to customer 601. FIG. 6C illustrates the checkout procedure. When a customer 601 is ready to check out, he sends the checkout request to server 107 through his EAT 101. The cashier terminal 105 receives the message and prints out the bill on printer. At the same time, it sends a “Bill is ready” message to the server 107 and the server 107 forwards this message to both service desk terminal 102 and EAT 101. Once the waiter gets the response message from the cashier terminal 105, he brings the bill to the customer 601.

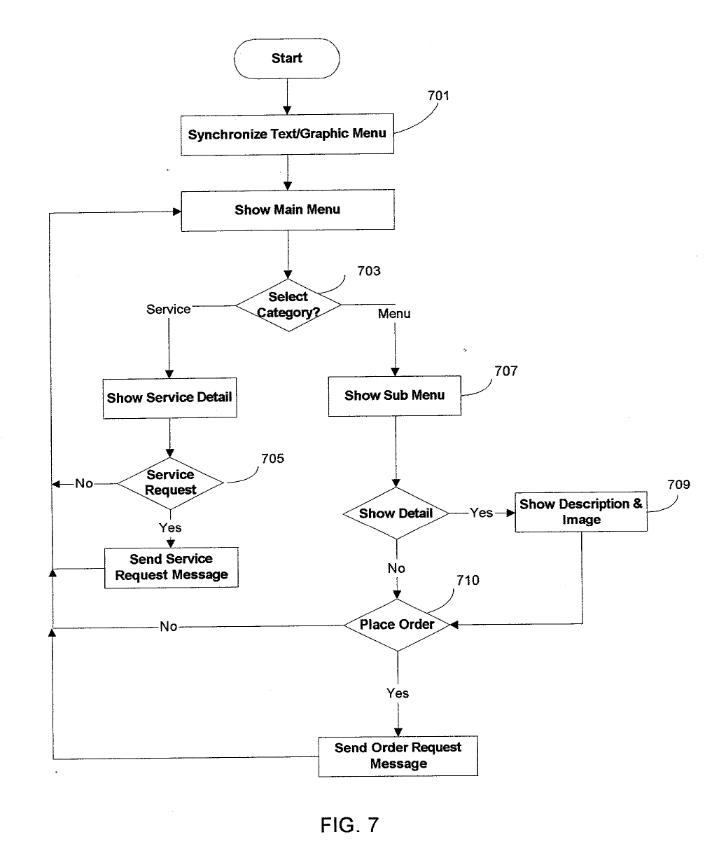

Referring to FIG. 7, a flow diagram of an EAT 101 user interface and operating procedure will be described. When the EAT device is reset, it will synchronize the text/graphic menu with the server. This synchronization process 701 is triggered only when there are some changes in food items or price. The graphic menu refers to a picture of each dish. By this means, customers will know what are their favorites. After the synchronization process, a main menu will be displayed on the EAT screen. Since the main menu includes both the service and food menu selection, customer can select either service or menu in step 703. If a service item is selected in step 705, the selected request will be sent to server and then to the appropriate destination. This will make customers feel convenient when they need something. The other select choice from step 703 is food menu, which will bring sub menu 707. Customers have the choice to view food detail and image in step 709. If they decide to order food from step 710, the order request will go to kitchen terminal through server. They can always add any item through this procedure. However, after they confirm the input, food item cannot be cancelled by through this procedure.

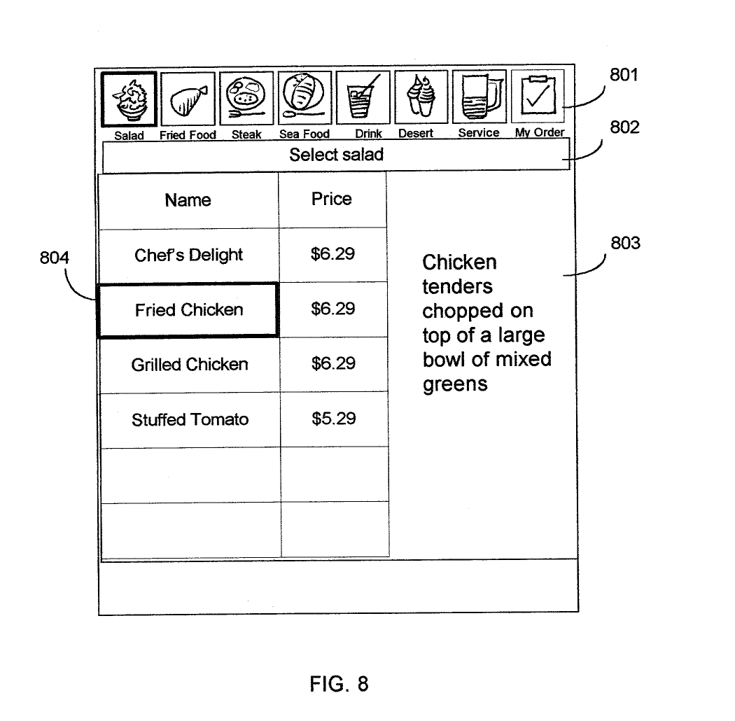

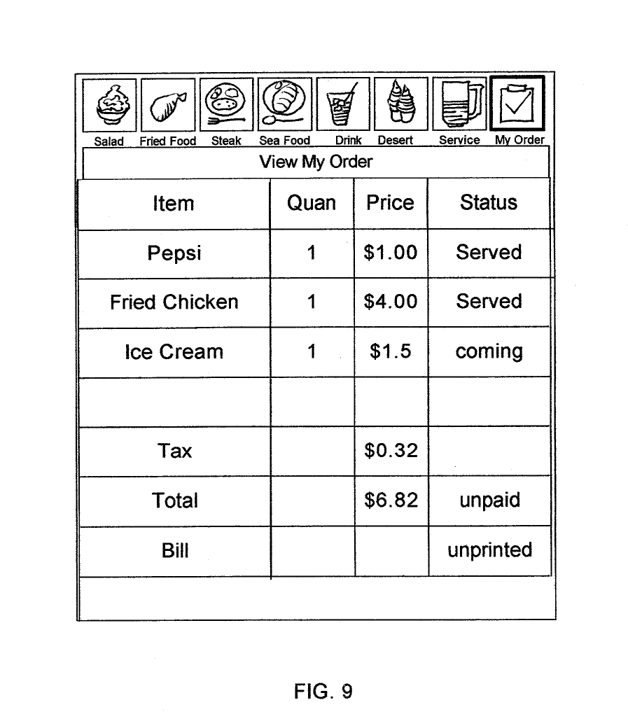

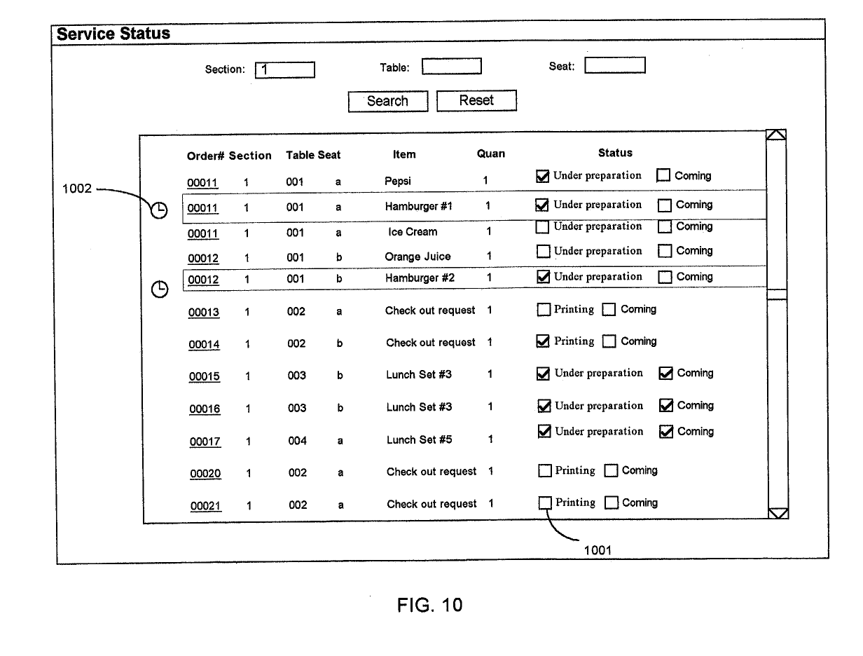

Customer browsers the menu items, showing on FIG. 8. On the top of display is the food service category 801 with a brief help tip text box 802. When customer navigates to a food item 804, the description of the food item will show on description panel 803. Once he keys in his choice, the item will show up on the service desk terminal 102 and other terminals according to the item category, e.g. food item also shows up on the kitchen terminal 103. For example, if a Pepsi is selected by a customer seated at table 001 seat a, the item is added on service desk terminal, FIG. 10, 1001. When a waiter catches the request, he selects either the “under preparation” or “coming” choice. This message is sent back to customer at table 001 seat a. If the customer clicks the “My Order” button on 801, he will see each item's status as the statement displayed on FIG. 9. If a service request is not answered in a promised service time window, a warning icon 1002 will show on service desk screen, FIG. 10. This setting is a monitor method to guarantee the service quality.

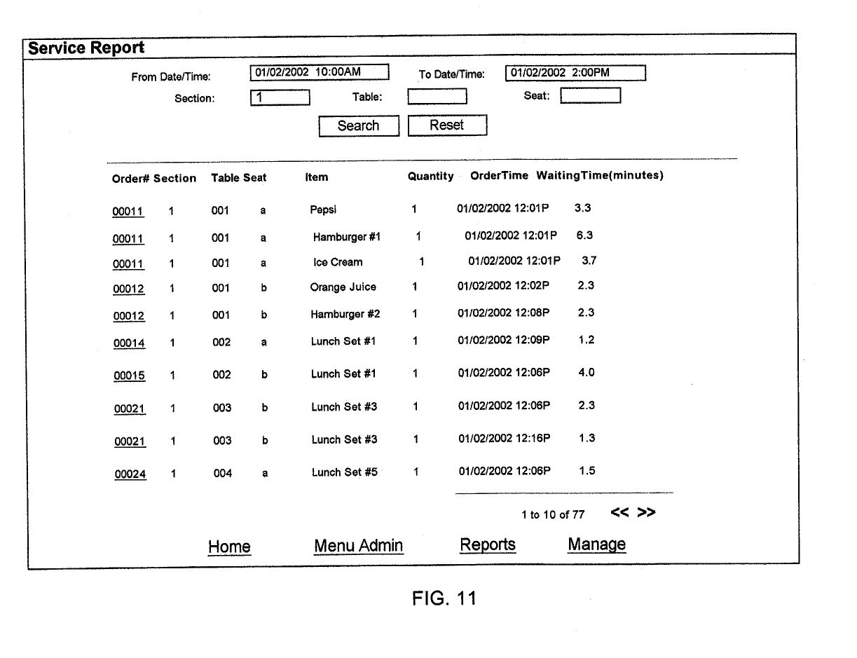

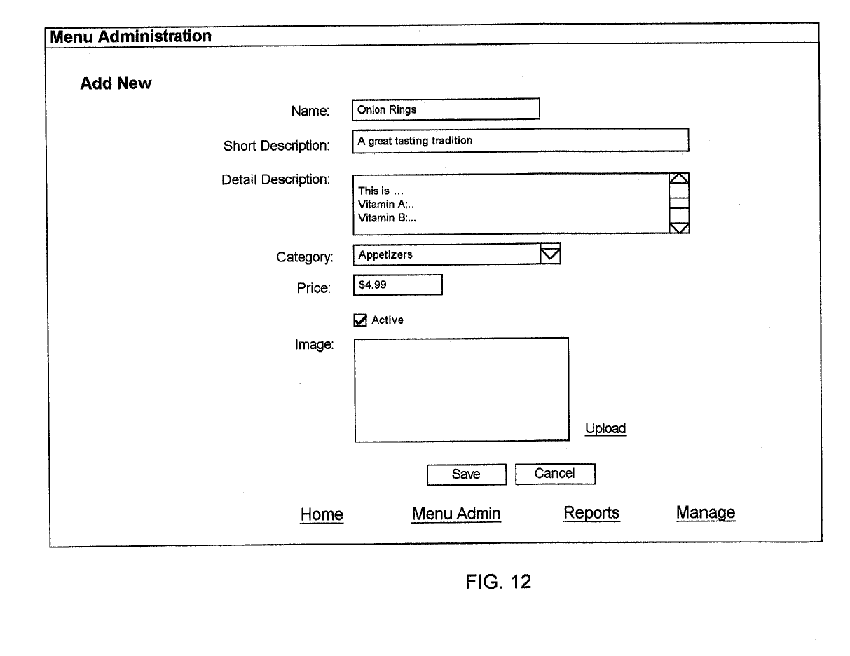

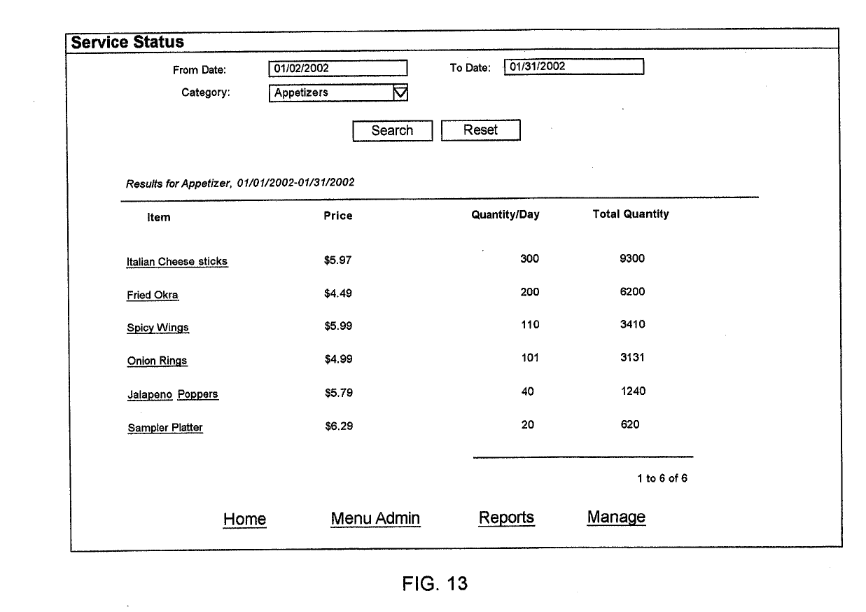

A Client Management Software Package, which is running on office terminals 106, is an agent of Server Management Software Package 410. It customizes individual restaurant's financial analysis and periodic reports generation. It manages the restaurant menu and employee task assignments. And it also allows the managers to view current service status showing on service desk terminal 102 via office terminal 106. FIG. 11 is an exemplary interface of service analysis report application. It allows the manager to view current service status report and history reports. These reports reflect the service quality. FIG. 13 is an exemplary Sale Report application running on the office terminals. This report will allow manager to analysis their sale information and adjust their menu and inventory. FIG. 12 is an exemplary Menu Administration application. This application adds new menu item and stores the item to server database. The text/graphic menu service application 409 on FIG. 4 uses the updated menu data to generate EAT menu.

We claim:

1. A restaurant management system comprising:
at least one server sending and receiving messages from participating terminals, and generating dynamic graphic and text menu interface;
plurality electronic assistant terminals with wireless network connection displaying said graphic and text menu interface, sending order and service requests, and listing service status;
at least one service desk terminal displaying said order requests, said service requests and said service status;
at least one kitchen terminal showing said order requests;

2. the restaurant management system of claim 1 wherein each said electronic assistant terminal having a unique identification code corresponding to each seat location and each customer taking one said electronic assistant terminal;

3. the restaurant management system of claim 1 wherein each said electronic assistant terminal navigating among said graphic and text menu interface by buttons;

4. the restaurant management system of claim 1 wherein said server wirelessly connected with said electronic assistant terminal and networked with other terminals by wired or wireless means;

5. the restaurant management system of claim 1 wherein said server running programs to maintain a database and dispatching messages to proper destinations;

6. the restaurant management system of claim 1, further including at least one office terminal pulling data from said database for analyzing and reports generating;

7. the restaurant management system of claim 1, further including a cashier terminal attached with a printer for bill printing.

8. A method of operating said restaurant management system comprising:
a customer requesting services by sending said order and service requests through said electronic assistant terminal to said server;
a service personnel in kitchen getting said customer's said order requests from said kitchen terminal and responding said customer's said order requests by sending responding messages through said kitchen terminal to said server;
a waiter getting said customer's said order and service requests from said service desk terminal and locating said customer by said unique identification code, then bringing correct items to the said customer, at mean time sending responding message to said server;
said server dispatching messages to correct destination terminals;
said customer getting responding messages displayed on said electronic assistant terminal;

9. the method of operating said restaurant management system of claim 8, further including bill printing at said cashier terminal if said customer sending a checking out message;

10. the method of operating said restaurant management system of claim 8, further including a management software package which generates reports, analyzes financial data and edits menu;

11. said management software package of claim 10 further including service quality monitoring function to displaying warning signal on said service desk terminal if said request does not get response in promised time window.
